(19) United States
(12) Patent Application Publication
(10) Pub. No.: US 2019/0043037 A1
(43) Pub. Date: Feb. 7, 2019

(54) SYSTEM AND METHOD FOR PROVIDING SECURED SERVICES

(71) Applicants: MARCO ANDRES GUIROLA MARTIN, SAN SALVADOR (SV); JORGE DANIEL LOPEZ MEDRANO, SAN SALVADOR (SV)

(72) Inventors: MARCO ANDRES GUIROLA MARTIN, SAN SALVADOR (SV); JORGE DANIEL LOPEZ MEDRANO, SAN SALVADOR (SV)

(21) Appl. No.: 15/666,652

(22) Filed: Aug. 2, 2017

(51) Int. Cl. G06Q 20/32; H04M 3/493; G06Q 20/30; G06Q 20/42

(52) U.S. Cl. CPC G06Q 20/3255; G06Q 20/42; G06Q 20/305; H04M 3/4936

(57) ABSTRACT

A system for providing secured services includes an unstructured supplementary service data platform for integration of technologies to create a secured payment using a digital link. A method for providing a secured service includes accessing an interactive voice response system with a user device, entering an identifier number into the interactive voice response system, verifying the identifier number, if verified sending a secured web link to the user device, the web link being pre-loaded with secured information and entering the web link at the user device to provide the secured information to a web service application.

### BACKGROUND OF THE INVENTION

### 1. Field of the Invention

The present invention relates to a system and method for providing secured services in which a secured point to point connection is established with a service to enable a secured transaction.

### 2. Description of Related Art

Authentication of services using a mobile device have been described. U.S. Pat. No. 7,606,560 describes authenticating a mobile device which is communicably connectable to a wireless network by an authentication parameter from a secure transaction server (STS), as a mobile device authenticator. An STS correlation is used between a personal identification entry (PIE) and the mobile device authenticator. The PIE is inputted by a user and a provider action to the mobile device authenticator transmits a transformed secure user authenticable authorization request to the STS over the wireless network to authorize an action with a provider.

A user can select purchases from a website the way she would normally do until she decides to checkout, at which point she typically needs to enter her payment information and approve of the transaction. The website displays to her the option of paying with her mobile phone. If the user chooses to pay with her mobile phone, the website sends a UPTF message (request transaction token) with a description of the transaction and the amount to be paid, to the STS and receives back a unique code, (Transaction Token1) that in turn is displayed to the user at the checkout page, inviting the user to approve payment from their mobile phone using the Transaction Token1 as a reference to this transaction. The STS determines that the user has authorized payment for the transaction referenced by Transaction Token1 to the provider (merchant) associated with the transaction referenced by Transaction Token1 and the STS sends the transaction for fulfillment to the relevant financial institution.

U.S. Patent Application No. 2007/0255653 describes a Mobile Person-to-Person Payment System. Through the mobile payment system and an access device such as their cell phone, users are able to send, request, and verify receipt of money, pay for services, pay for bills, pay for movie tickets, pay for groceries, pay a babysitter, pay for coffee and a newspaper, pay back a friend, split a dinner bill, send money to children, get money from parents, get quick or emergency cash, send emergency cash, pay up or collect on a friendly wager, pay for fantasy football, pay for gardening services, pay for association dues, track purchases, check the balance, and more. In addition, in at least some embodiments each of these transactions is effected substantially in real time, with good funds that are immediately available to the recipient. The user validates each of the new identities for an account. This can be done through an IVR callback or responding to an SMS message in the case of a phone number. For an e-mail, it can be done through sending an e-mail with a unique URL or a pass code that the user would respond with on our webpage. And with an instant messenger ID, it can be done by responding to an IM.

US Patent Application number 2009/0182674 describes systems and methods for communicating with a user device via a network, receiving a first numeric identifier from the user device, associating the first numeric identifier with a user account, and processing a financial transaction requested by the user device. The user device includes a mobile phone, and the first numeric identifier includes a mobile phone number associated with the user device. The disclosure describes facilitating financial transactions over a network using a mobile device by establishing a financial transaction account or by creating a financial transaction record. For example, in one implementation, a user may set up an account from a mobile device without manually entering user information, which may be retrieved from a database. The database may be an electronic phone listing service, a service provided by the local phone company, or some other entity with a database adapted to map user information to phone numbers. The database may be maintained by a mobile device network service provider. For example, when a user obtains or purchases a device, the user may be given the option of sharing their user information with a payment service.

In one embodiment, a user establish an account associated, for example, with a mobile device by pressing an appropriate key or keys on the mobile device. The phone number for the mobile device may be automatically sent to the telephone service provider, or the user may respond to a prompt by entering their device identifier, for example their telephone number. The user may be asked to enter an additional data set, for example the postal code where their billing address is located or a partial street or postal address, for example the street numbers. The additional data set may comprise a PIN for identification purposes. The system may access a database to search for a match for the telephone number. The system may store the user information in a database, which may be mapped to the user's device so that any subsequent purchases from the device may be recognized as being made by the particular user. The user may input billing information, for example, a credit card number, which may be entered and stored in the database for use in future transactions.

The above described references have the shortcomings that associating a PIN with a device or a person and linking accounts for enabling transfers have the potential for being fraudulently compromised. It is desirable to provide a method for providing secured transactions without associating a device with a person or establishing a linked account to the device.

### SUMMARY OF THE INVENTION

The present invention relates to a system for providing secured services in which an unstructured supplementary service data platform provides integration of technologies to create a secured payment using a digital link. The present invention has the advantage that all sensitive data are input by a user using a secure link and are not input by the user into a call center via a keyboard into an interactive voice response (IVR). All sensitive data, including for example, credit information, device and browser identification, is entered onto a secured services webpage, such as a payment screen, via a pre-loaded link previously sent in a text message to the user's device.

In one aspect, a method for providing a secured service includes accessing an interactive voice response system with a user device, entering an identifier number into the interactive voice response system, verifying the identifier number, if the identifier number is verified, sending a secured web link to the user device, the web link being pre-loaded with secured information and entering the web link at the user device to provide the secured information to a web service application.

In another aspect, a computer program product, tangibly embodied in a machine readable storage media, includes instructions for causing a processor to perform any of the methods or features described above.

In another aspect, a system for providing secured services includes a customer mobile device, IVR and an application server. The IVR is configured to receive user input. The input can include identification numbers and other characteristics and selection of options within the IVR, the latter dependent on the particular IVR menu. An application server establishes a web socket connection to a secured service gateway. For example, the secured services gateway can be a payment gateway. The user input can be forwarded to the secured services gateway. If the user input is verified, the secured services gateway sends a secured web link to the user device, the web link being pre-loaded with secured information and entering the web link at the user device to provide the secured information to the secured services gateway. An example of such a link is the description, amount, beneficiary and terms of a payment.

The invention will be more fully described by reference to the following drawings.

### BRIEF DESCRIPTION OF THE DRAWINGS

FIG. 1 is a schematic diagram of a system for providing secured services in accordance with the teachings of the present invention.

FIG. 2 is a flow diagram of a method for providing secured services in accordance with the teachings of the present invention.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

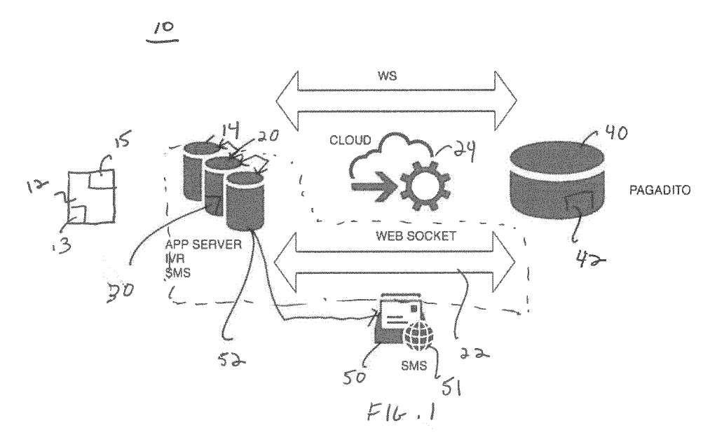

FIG. 1 shows an embodiment of secured services system 10 in accordance with the teachings of the present invention. User device 12 accesses interactive voice response (IVR) system 14. User device 12 can be a cellular phone. User device 12 can be a mobile computing device, ie. a hand-held computing device capable of running a user application. For example, user device 12 can be a smart phone or tablet computer or it can be a desktop computer, a laptop computer or other data processing apparatus. User device 12 can interact with IVR system 14 with the use of voice and dual-tone multi-frequency signaling (DTMF) tones input via keypad 13 of user device 12 or an application running on user device for a keypad. IVR system 14 allows customers to interact with a company's host system via a telephone keypad or by speech recognition, after which services can be inquired about through the IVR dialogue. In one embodiment, a user application 15 is downloaded to user device 12, e.g., through an application store.

Application server 20 receives manages and receives communications from IVR system 14. Web service application 30 can run on application server 20. Web socket 22 establishes a connection over network 24 between application server 20 and service gateway 40. For example network 24 can be the Internet. Network 24 can include cloud computing. Web service application 30 can verify data received from IVR system 14.

Web service application 30 can request a link to services gateway 4. Web service application 30 can create message 50 including link 51 to services gateway 40. In one embodiment, message 50 can be a short message service (SMS) message. The SMS message is generated by SMS server 52. Link 51 can include a uniform resource locator (URL) address of webpage 42 for services gateway 40.

In one embodiment, services gateway 40 is a payment gateway. Webpage 42 can display a good or service. Webpage 42 can include a payment screen or a link to a webpage displaying the payment screen. Link 51 can be pre-loaded with payment data to be accessed by services gateway 40 to complete payment for the good or service. Web services gateway 40 can send a confirmation of completion of a service, for example payment, to web service application 30. Web service application 30 can send a confirmation to user device 12 of a completion of a service, for example a payment.

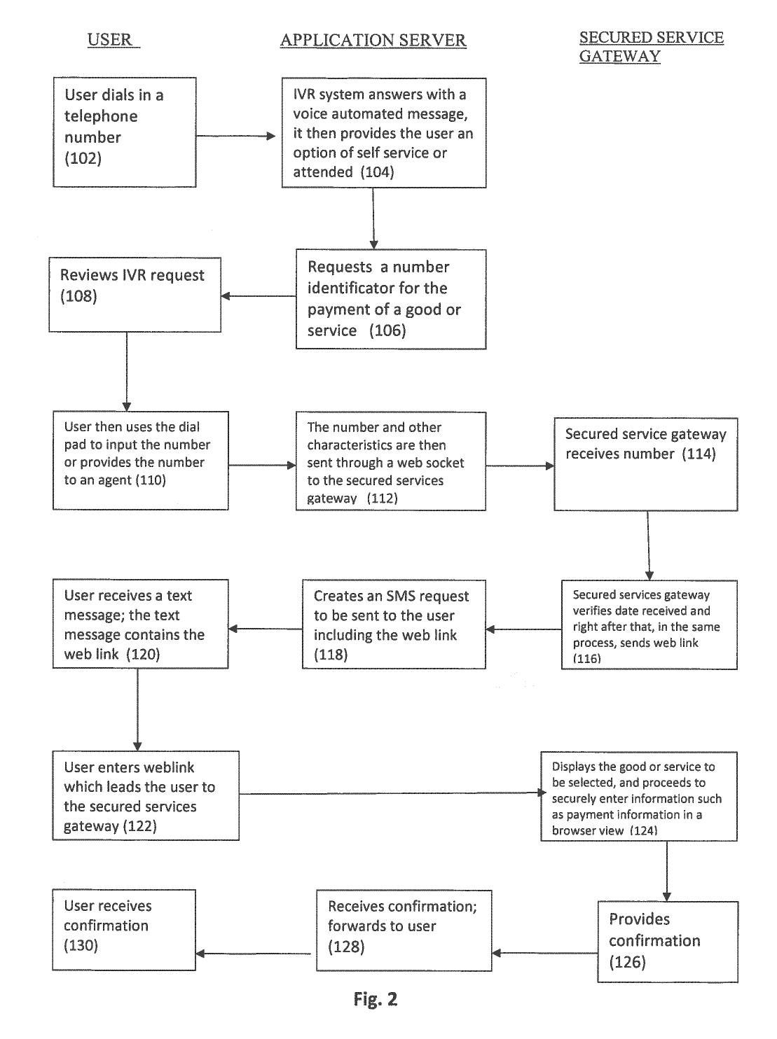

FIG. 2 is a diagram of an example flow chart of process conducted with secured services system 10. The process conducted with secured services system 10 involves relationships between user device 12, application server 20, and services gateway 40.

A user dials in a telephone number using user device 12, e.g. 22597111 (step 102), IVR system 14 answers with a voice automated message. IVR system 14 then provides the user 2 options: a first one of self service and a second one, to be attended by an agent in a call center through the voice call (step 104).
If the self service option is chosen, IVR system 14 asks the user for a number identifier for the payment of a good or service (step 106). The user reviews the IVR request (step 108) The user then uses a dial pad of user device 12 to input the number identifier. If the attended by an agent option is selected, the user provides the number identifier to an agent (step 110). The number identifier and other characteristics are then sent through web socket to secured services gateway 40 (step 112), ie. second service can be a payment platform at www.Pagadito.com.
Secured services gateway 40 receives the number and other characteristics (step 114). Data received at secured services gateway 40 is verified and right after that, in the same process, secured services gateway 40 generates a link to secured service gateway 40 (step 116). As a result of this verification web service, application 30 creates a text request to be sent to the phone number of user device 12 that was used to initiate the call by the user (step 118). The text message sent contains a web link with a URL that leads the customer to the secured services gateway. The user receives the text message (step 120). The user enters the weblink, for example at user device 12 or an alternate device such as a laptop computer, (step 122). Secured services gateway 40 displays the good or service to be selected for payment (step 124). In one implementation, secured services gateway 40 displays on the graphical user interface (GUI) of user device 12. In some implementations, through the GUI of user device 12, the user can select items that the user has sought to purchase. The application can be configured to associate individual prices with each of the merchant's items, and the application can automatically sum the total transaction amount that the user owes. From the link, information, such as payment information, is securely entered into a browser view of secured services gateway 40 to finish the process (step 124). Secured services gateway 40 provides a confirmation (step 126). Application server 20 then receives confirmation that the transaction has come to an end, and that the customer has been served (step 128). Application server sends the confirmation to user device 12 (step 130).

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a non-transitory computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices). The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed:

1. A method comprising:
accessing an interactive voice response system with a user device;
entering an identifier number into the interactive voice response system;
verifying the identifier number and if verified sending a secured web link to the user device, the web link being pre-loaded with secured information; and
entering the web link at the user device to provide the secured information to a web service application.

2. The method of claim 1 wherein the secured web link is sent to the user as an SMS text message.

3. The method of claim 1 wherein after receiving the web link, a webpage of the service displays a good or service to be selected.

4. The method of claim 1 further comprising the step of:
providing a confirmation to the user from the service web service provider.

5. The method of claim 1 wherein the secured information is payment information and the web service application provides payments for a good or service.

6. The method of claim 1 wherein the user device is a cellular phone, smart phone or tablet.

7. A computer program product, embodied on one or more non-transitory machine readable storage media, comprising instructions that when executed by one or more computers cause the one or more computers to perform operations comprising:
accessing an interactive voice response system with a user device;
entering an identifier number into the interactive voice response system;
verifying the identifier number and if verified sending a secured web link to the user device, the web link being pre-loaded with secured information;
entering the web link at the user device to provide the secured information to a web service application.

8. The computer program product of claim 7 wherein the secured web link is sent to the user as an SMS text message.

9. The computer program product of claim 7 wherein after receiving the web link, a webpage of the service displays a good or service to be selected.

10. The computer program product of claim 7 further comprising the step of:
providing a confirmation to the user from the service web service provider.

11. The computer program product of claim 7 wherein the secured information is payment information and the web service application provides payments for a good or service.

12. The computer program product of claim 7 wherein the user device is a cellular phone, smart phone or tablet.

13. A system for providing a secured service comprising:
a user device that accesses an interactive voice response system with a user device and enters an identifier number into the interactive voice response system; and
a web service application for verifying the identifier number and if verified sending a secured web link to the use device, the web link being pre-loaded with secured information,
wherein the web link at the user device to provide the secured information to a web service application.

14. The system of claim 13 wherein the secured web link is sent to the user as an SMS text message.

15. The system of claim 13 wherein after receiving the web link, a webpage of the service displays a good or service to be selected.

16. The system of claim 13 further comprising the web service application providing a confirmation to the user from the service web service provider.

17. The system of claim 13 wherein the secured information is payment information and the web service application provides payments for a good or service.

18. The system of claim 13 wherein the user device is a cellular phone, smart phone or tablet.
